(19) United States
(12) Patent Application Publication
(10) Pub. No.: US 2004/0184124 A1
(43) Pub. Date: Sep. 23, 2004

(54) Optical deflection device

(75) Inventors: Tetsuo Ikegame, Hachioji City (JP); Tetsuyuki Sakamoto, Hachioji City (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Corporation, Tokyo (JP)

(21) Appl. No.: 10/705,275

(22) Filed: Nov. 10, 2003

Related U.S. Application Data
(60) Provisional application No. 60/425,805, filed on Nov. 13, 2002.

(51) Int. Cl. G02B 26/08

(52) U.S. Cl. 359/204; 359/216

(57) ABSTRACT

An optical deflection device is disclosed. The device comprises an optical deflection element having a prescribed deflecting plane of deflecting a direction of light, a drive portion for driving the optical deflection element rotatably at least, a fixing portion for supporting and fixing the optical deflection element, a movable portion including above optical deflection element, a support member connected with the fixing portion and for supporting this, and a damping member installed between the movable portion and the fixing portion.

### BACKGROUND OF THE INVENTION

1. Field of the Invention

The present invention relates to an optical deflection device.

2. Prior Art

The optical deflection device is used for various applications, and especially, the galvanometer mirror is used partially of a magnetic-optical disk drive, a write once disk drive, a phase change type disk drive, an information record player for recording and/or reproducing information to optical recording media such as CD-ROM, DVD, and optical cards, and an optical element supporting means for inclining luminous flux in the prescribed direction in an optical device such as an optical scanner and an optical deflection machines for optical communication.

For example, in Japanese Patent Application Opened No. 72,409/1995 as shown in FIGS. 16 and 17, a small optical element supporting device (Hereafter, referred to as prior art 1) is disclosed. The optical element supporting device are installed in glass substrate 34 to which an electrode is formed with a vibrator 30, through a spacer 35. The vibrator 30 constitutes from a movable plate 31 for arranging a reflector (mirror) thereon and molded from silicon of thickness 0.3(mm) integrally with etching, and a frame 33 installed integrally to the movable plate 31 through S shaped span bounce 32, and the thickness of the movable plate 31 and the span bounce 32 is made 20(μm). In vibrator 30, the vibration is performed since electrostatic force acts between the two when the voltage is applied between electrodes formed to movable plate 31 and glass substrate 34, movable plate 31 centers on span bounce 32, and is sucked to the electrode.

In Japanese Patent Application Opened No. 72,409/1995, as shown in FIG. 18, a small optical element supporting device (Hereafter, referred to as prior art 2) is also disclosed. In the optical element supporting device, the mirror being the reflecting mirror constitutes a mirror outer periphery portion 42 connected to a gap formation portion 43 formed on a glass substrate 44, and a mirror portion 40 non-contacted to the gap formation portion 43 and supported through a beam 41 extended from the mirror outer periphery portion 42, and thus the mirror portion 40 doubles as the function of the movable plate.

However, in the above described prior art, the inconvenience as explained hereinafter, was caused respectively.

First, in the prior art 1, as shown in FIGS. 16 and 17, the span bounce 32 has been provided to the side of the movable plate 31 being reflection plane, so that the rigidity in the direction (perpendicular direction) orthogonal to the surface of the movable plate 31 is low, thereby being able to vibrate in the direction of the perpendicular. Therefore, there was an inconvenience called that the light reflected on the surface of movable plate 31 is moved in parallel, and thus the deviation is caused for the target position.

Next, in the prior art 2, when the vibration is added in the direction (perpendicular direction) orthogonal to the reflection plane of the mirror portion 40, the back of the mirror portion 40 collides with the gap formation portion 43, so that the rotating drive of the mirror portion 40 is not steady. Additionally, there is no restriction in the direction in which the mirror portion 40 move away from the gap forming portion 43, so that the vibration in the direction that mirror portion 40 move away from the gap forming portion 43 cannot be restricted. In addition, the beam 41 is positioned at the side of the mirror portion 40, thereby causing the flexure in the direction perpendicular to the mirror portion 40, so that the rigidity was not too large, and thus the beam was easy to have vibrated. Therefore, in the prior art 2, also there was an inconvenience called that the light reflected on the surface of the mirror portion 40 is moved in parallel, and thus the deviation is caused for the target position.

### SUMMARY OF THE INVENTION

The present invention is performed so as to overcome the above described problem, and has for its object to provide an optical deflection device capable of constraining the vibration in the direction perpendicular to the deflecting plane such as reflection planes of the reflecting mirror effectively.

In order to achieve the above object, according to the present invention, there is an optical deflection device comprising an optical deflection element having a prescribed deflecting plane of deflecting a direction of light, a drive portion for driving the optical deflection element rotatably at least, a fixing portion for supporting and fixing the optical deflection element, a movable portion including above optical deflection element, a support member connected with the fixing portion and for supporting this, and an damping member installed between the movable portion and the fixing portion.

Moreover, in the preferable embodiment of the present invention, the damping member is installed in the vertical direction substantially compared with the deflecting plane.

Moreover, in other preferable embodiments of the present invention, the damping member is installed in neighborhood at the rotation center of the optical deflection element.

Moreover, in other embodiment of the present invention, the damping member is installed at the center part of the movable portion substantially at the rear side opposed to the deflecting plane of the movable portion. In this case, the fixing portion has a projection extended to the rear side of the optical deflection element almost in the center part, and the damping member is provided between the optical deflection element and the projections of the fixing portion.

### BRIEF EXPLANATION OF DRAWING

FIG. 1 is a system chart of an optical path switching device including a galvanometer mirror with the damped structure as first embodiment of the present invention;

FIG. 2 is a perspective view showing the galvanometer mirror having the damped structure as first embodiment of the present invention;

FIG. 3 is an exploded view of FIG. 2;

FIG. 4 is a front view showing the galvanometer mirror of FIG. 2;

FIG. 5 is an inner view showing the galvanometer mirror of FIG. 2 from the inside;

FIG. 6 is a cross-sectional view showing around the holder of the galvanometer mirror of FIG. 2;

FIG. 7 is a cross-sectional view showing the galvanometer mirror of FIG. 2;

FIG. 8 is a longitudinal sectional view showing the galvanometer mirror 100;

FIG. 9 is a cross-sectional view showing the modified embodiment of first embodiment;

FIG. 10 is an exploded perspective view showing the galvanometer mirror having the damped structure as second embodiment of the present invention;

FIG. 11 is a cross-sectional view showing the galvanometer mirror of FIG. 10;

FIG. 12 is a perspective view showing a part of the galvanometer mirror in the modified embodiment of second embodiment of the present invention;

FIG. 13 is a cross-sectional view showing a part of the galvanometer mirror in the modified embodiment of second embodiment of the present invention;

FIG. 14 is an exploded view showing third embodiment of the present invention;

FIG. 15 is a cross-sectional view of the principal portion shown in FIG. 13;

FIG. 16 is perspective view showing conventional embodiment of the galvanometer mirror by cross-section in part;

FIG. 17 is a system chart showing the galvanometer mirror of FIG. 17; and

FIG. 18 is a perspective view showing another conventional embodiment of the galvanometer mirror.

### DETAILED EXPLANATION OF THE INVENTION

Hereafter, the embodiment of the present invention is explained in detail based on the accompanying drawing.

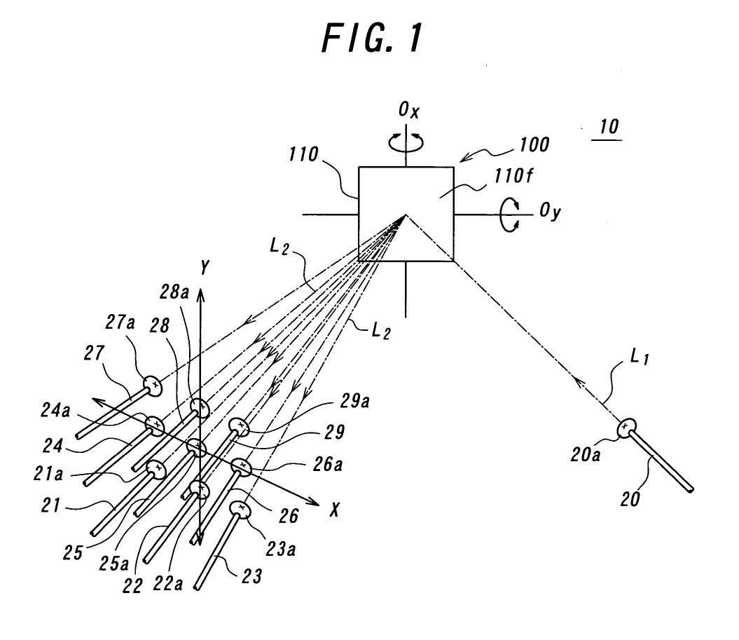

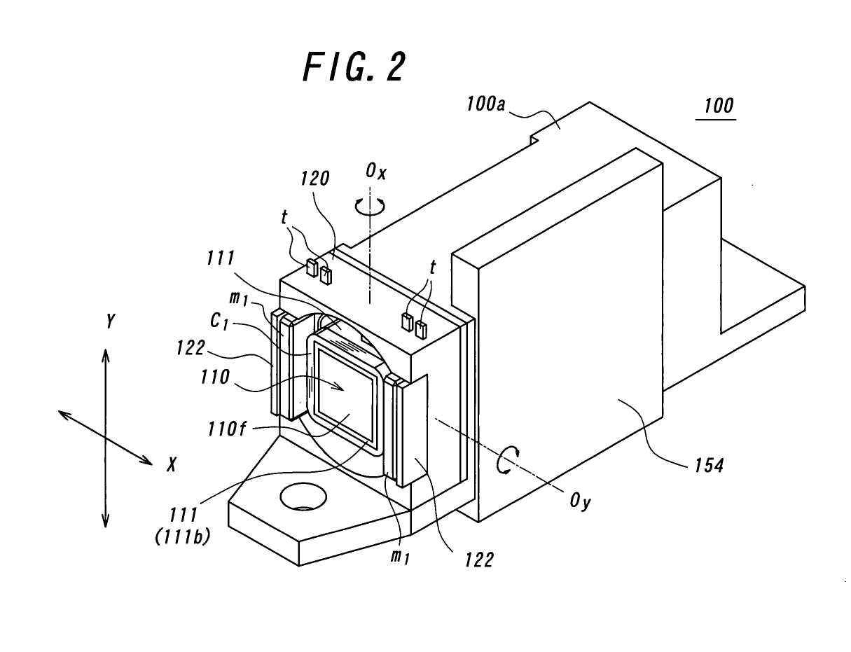

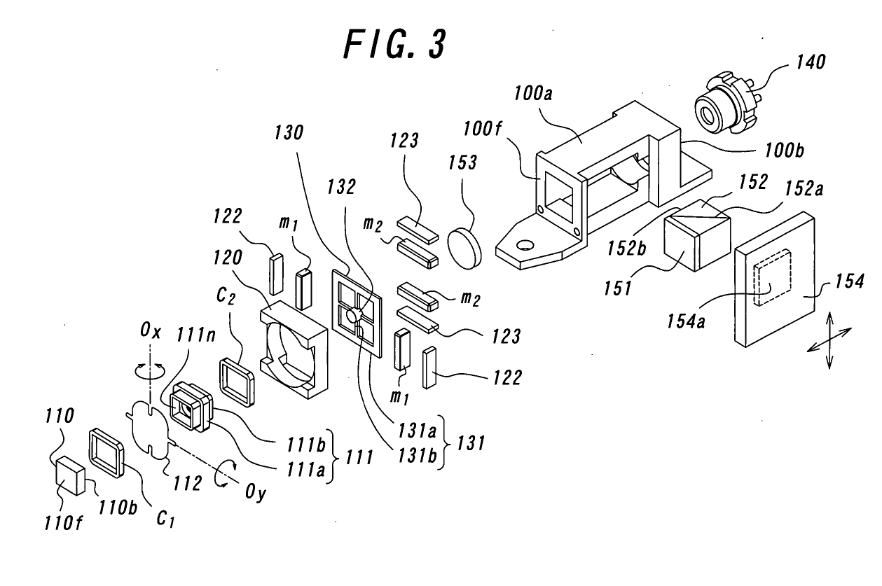

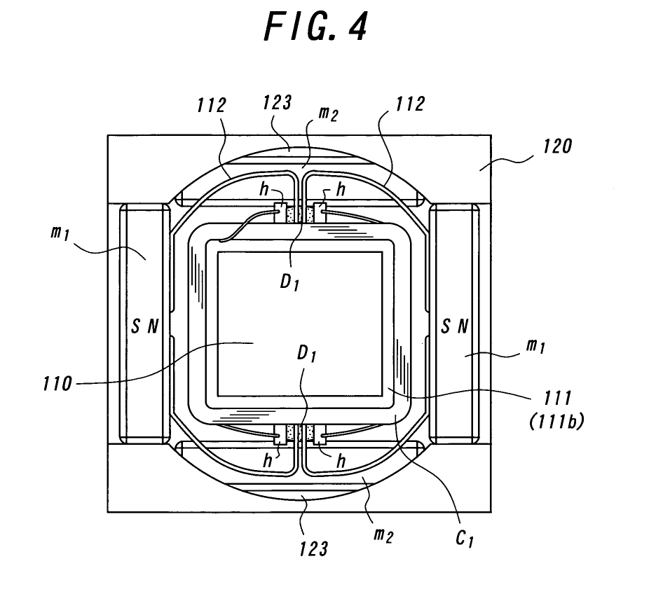

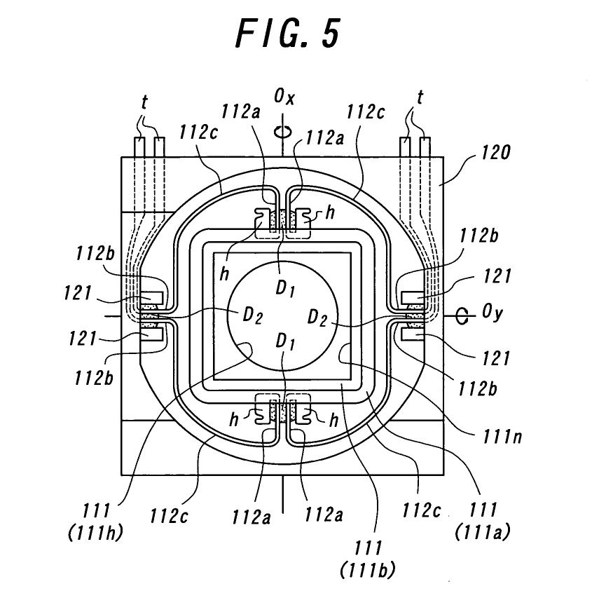

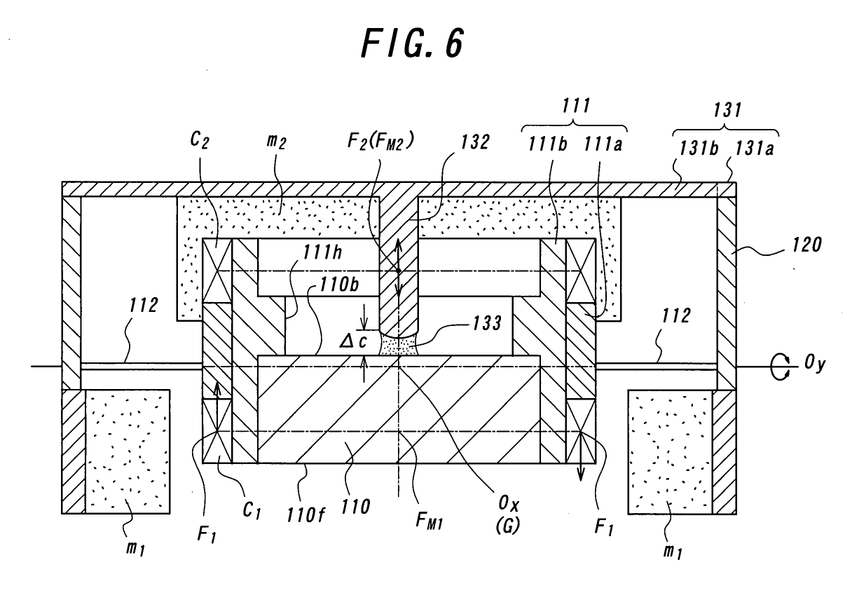

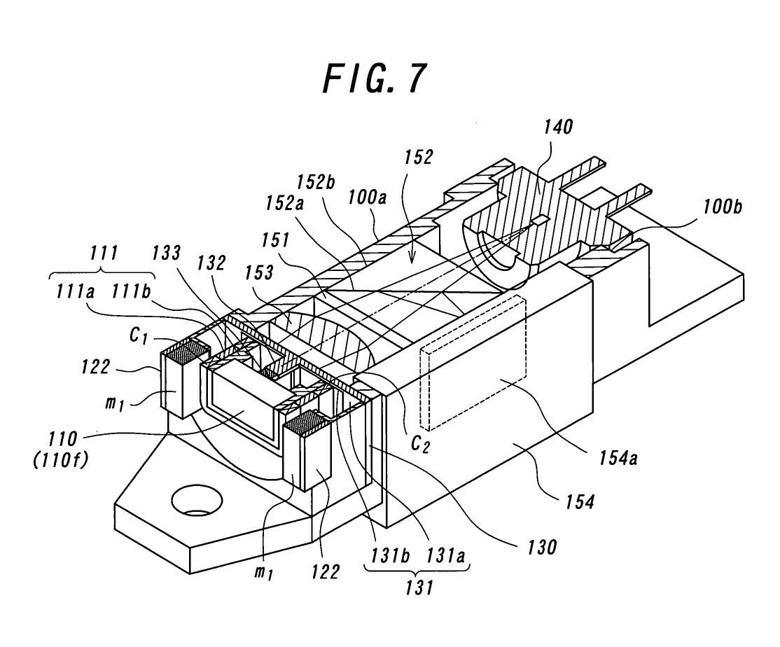

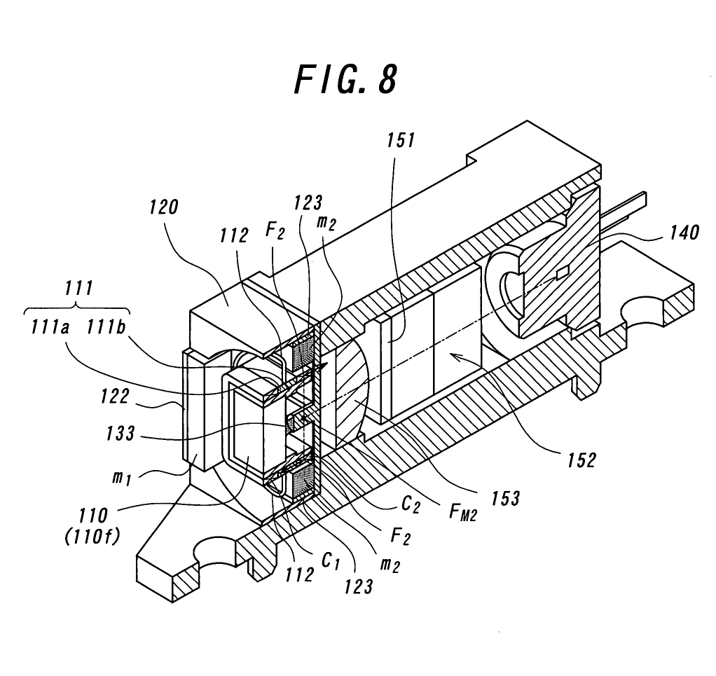

FIG. 1 is a system chart showing the optical deflection device being first embodiment of the present invention in the outline. In this embodiment, a galvanometer mirror 100 is shown as one example of the optical deflection device. Moreover, FIG. 2 is an oblique perspective view showing the galvanometer mirror 100 which is the first embodiment of the present invention, FIG. 3 is an exploded view of the galvanometer mirror 100, FIG. 4 is a front view of the galvanometer mirror 100, FIG. 5 is an inner view where the mirror of the galvanometer mirror 100 is shown from the inside, FIG. 6 is a cross-sectional view showing the surrounding of the holder of the galvanometer mirror 100, FIG. 7 is a cross-sectional view showing the galvanometer mirror 100, and FIG. 8 is a longitudinal sectional view showing the galvanometer mirror 100.

As shown in FIG. 1, an optical path switching device 10 comprises one optical fiber 20 for emanating light being transmission signals for optical communication, a galvanometer mirror 100 for reflecting the light emitted from the optical fiber 20, and a plurality of optical fibers 21-29 on which reflected light is incident. The optical fiber 20 comprises a lens 20a arranged so as to correspond an optical axis to the tip of the lens 20a, and similarly, optical fibers 21-29 are arranged by nine totals of three steps three rows in the coplanar, and comprise lenses 21a-29a arranged so as to correspond its optical axes at the tip thereof respectively.

A mirror 110 being the reflecting mirror constituted as the galvanometer mirror 100, is supported by a spring 112 (refer to FIG. 3) being the support member described later rotatably around two rotating axes Ox and Oy that are mutually orthogonal, respectively, and similarly, the inclination of the mirror 110 is made to be able to be set freely, by applying the driving signal (electric current) to the following exciting coils C1 and C2 and by rotating the mirror 110 around the rotation axes Ox and Oy.

Therefore, the optical path switching device 10 makes the light emanated from the optical fiber 20 a parallel light by a lens 20a, the emitted light L1 is projected on an obverse side (reflection plane) 110f of the mirror 110, and a reflected light L2 from a reflection plane 110f is made incident selectively on one of nine optical fibers 21-29 through either one of nine lenses 21a-29a, by rotating the mirror 110 around rotation axis Ox and Oy with the above driving signal.

As a result, the optical path switching device 10 can output the light output from one optical fiber 20 to selected one of nine optical fibers 21-29. Moreover, incident light L1 and reflected light L2 are principal rays deflected by the mirror 110 of the galvanometer mirror 100.

Concretely, the reflected light L2 on the mirror 110 is deflected in X direction as shown in FIG. 1, by inclining the mirror 110 around the rotation axis Ox, and the reflected light L2 on the mirror 110 is deflected in Y direction as shown in FIG. 1, by inclining the mirror 110 around the rotation axis Oy. As a result, for example, the galvanometer mirror 100 changes the direction of reflected light L2 from lens 21a to lens 29a, thereby being able to make the reflected light L2 incident on from the optical fiber 21 to the optical fiber 29. Moreover, the mirror 110 may tilt only either one of around the rotation axis Ox or around the rotation axis Oy, thereby deflecting the reflected light L2.

Here, the galvanometer mirror 100 is explained as first embodiment of the present invention.

As shown in FIG. 2, the galvanometer mirror 100 is arranged at a central portion of a magnet holder 120, to which the mirror 110 is mounted at a front opening of the housing 100a, and comprises a supporting drive mechanism for supporting rotatably the mirror 110 about the rotation axis Oy parallel to the horizontal direction X, and the rotation axis Ox parallel to the horizontal direction X orthogonal to the vertical direction Y, and a position detecting device arranged in the housing 100a at the reverse side of the mirror 110, in such a manner that the rotating deviations around two rotation axes Ox and Oy of the mirror 110 are detected (utilized light to two dimensional or two directions).

The mirror 110 is a square (or rectangular) plate shape as shown in FIG. 2, a reflection plane 110f on the obverse side thereof, is coated with a coating film in such a manner that the reflectivity becomes increased, compared with wavelength 1.3(μm)-1.7 (μm) of the principal ray used for the optical communication. Moreover, the coating film is coated on a reverse side 110b of the mirror 110 (refer to FIG. 3) in such a manner that the reflectivity of a laser 140 (refer to FIG. 3) for generating light for the sensor for example to wavelength 780(nm) becomes increased. In addition, the mirror 110 is housed in a fitting recess portion 111n (refer to FIG. 3) existed at a central portion of a mirror holder 111 with a square frame shape, and its surroundings are cemented and fixed in a positioned state.

Concretely, as shown in FIG. 6, the mirror holder 111 consists of a prime parts 111a formed outer side in a square frame shape and a second parts 111b formed inside of the parts 111a in a substantially square frame shape, and the mirror 110 is housed and fixed in a fitting recess portion 111n formed in front of the parts lib. Parts 111a are formed stepwise at central position in a back and forth direction at outer sides of parts 111b substantially, and stepwise portions of the parts 111a and outer peripheral surfaces of adjacent parts 111b have a function for fixing and holding first coil C1 and second coil C2.

Moreover, four springs 112 (112a, 112b, 112c) of substantial circular arc shape are arranged at outer periphery position of the parts 111a as shown in FIG. 5, and both ends of the spring 112 are inserted in the magnet holder 120, even though the spring 112 and the magnet holder 120 are resolved and shown as another body, in FIG. 3.

Concretely, as shown in FIG. 5, when parts 111a and magnet holders 120 of mirror holder 111 are molded with the plastic, an inside portion of four springs 112 formed by a foil of 20(μm) of beryllium copper with etching process, and applied with gold plate on its surface, is firstly inserted in parts 111a of the mirror holder 111, and an outer side portion thereof is firstly inserted in the magnet holder 120, and both ends thereof are held.

Then, the mirror 110 fixed to the mirror holder 111 and first coil C1 and second coil C2 installed on the outer peripheral surface of the mirror holder 111 constitute the movable portion, by inserting first coil C1 and second coil C2 on both sides before and behind the spring 112 at the molding of parts 111b.

In addition, when explaining in detail, as shown in FIG. 5, four springs 112 are fixed at its one end to two respective places at a center of the upper surface and a center of the undersurface near the rotation axis Ox of the mirror holder 111, and the vicinity of its fixed end has first deformed portion 112a deformed in such a manner so as to become parallel to the rotation axis Ox. Soldering portion h connected to the first deforming portion 112a inside of the mirror holder 111 is arranged in vicinity of the first deforming portion 112a, and, the both ends end of the first coil C1 and the second coil C2 are fixed to the soldering portion h in four places in total with the electrical conductivity adhesive.

Moreover, the other end portion of the spring 112 is fixed to two places respectively by right and left side walls near the rotation axis Oy of the magnet holder 120, and the vicinity of its fixed end of the other end portion has second deformed portion 112b deformed in such a manner so as to become parallel to the rotation axis Oy. Moreover, the edge of second deforming portion 112b extends through the rectangular protrusion 121 projected from right and left sides of the magnet holder 120, and is inserted in the magnet holder 120. However, the inserted portion passes through the magnet holder 120 and is arrived to four terminals t projecting outside of the magnet holder 120.

In addition, the spring 112 has the connecting portion 112c for connecting first deforming portion 112a and second deforming portion 112b, and the connecting portion 112c is arranged so as to surround four corner of the mirror holder 111. The spring 112 having these 4 deforming portions 112a, second deforming portion 112b, and the connecting portion 112c, becomes a support member in the present embodiment.

Dumpers D1 and D2 being UV curing silicon gel are provided to first deforming portion 112a and soldering portion h, as well as second deforming portion 112b and the protrusion 121 so as to connect and touch them therebetween, thereby holding the damping function to the vibration in both ends of the spring 112. The spring 112 being the above support member supports the above movable portion and the above fixing portion by the connection or the contact of the dumpers D1 and D2 as the damping member.

As shown in FIGS. 3, 4 and 6, the magnet holder 120 is fixed to two horizontally magnetized magnets m1 together with respective yokes 122 at its back, and the first coil C1 is fitted to inside of these magnets m1 at the opposed right and left places by adhesive material. As a result, the magnetic circuit is constituted in such a manner that the magnetic field due to the magnet m1 acts on the first coil C1 oppositely arranged inside.

Moreover, as shown in FIG. 3, the magnet holder 120 is fixed to two vertically magnetized magnets m2 together with respective yokes 123 at its back, and the second coil C2 is fitted to inside of these magnets m2 at the opposed up and down places by adhesive material.

As a result, the mirror 110, the mirror holder 111, and the movable portions consisting of two coils C1, C2 are supported tiltablly to the magnet holder 120 through four springs 112 as support member, and the flexible cable is soldered to four terminals t (refer to FIG. 5), and thus, by feeding power through the flexible cable, the driving signal is supplied to two coils C1 and C2 through four springs 112, thereby being able to rotate the mirror. That is, the mirror 110 can be tilted only to the amount corresponding to the driving force caucused in the first coil C1 and the second coil C2 through the mirror holder 111.

The mirror holder 111 and the magnet holder 120 are molded with a non-conductive plastic (for example, fiberglass or liquid crystalline polymer with titanic acid whiskers). The magnet holder 120 is a squarish frame shape and is cemented to the fitting face 100f opened in front of the housing 100a molded with, for example, zinc diecast.

As shown in FIG. 3, in the present embodiment, a plate 130 is fixed to the back of the magnet holder 120. The plate 130 comprises a main body portion 131 fitted to the back of the magnet holder 120, and a projection 132 extended through the magnet holder 120 from the front side to back 110b of the mirror 110, and having a tip of sphered cylinderical shape, at the central portion of the main body portion 131, and as shown in FIGS. 6-8, a damping member 133 (damping member) contacted to the back 110b of the mirror 110, is provided to the tip of the projection 132.

In the present embodiment, the projection 132 of the plate 130 is positioned at a central portion of the main body portion 131, and the surroundings of the projection 132 are connected to the outer periphery portion 131a of the plate 130 by four thin connecting portions 131b.

Moreover, in this embodiment, when the plate 130 is fixed to the back of the magnet holder 120, slight gap Δc (for example, 0.2-1 mm) is caused between the back 110b of mirror 110 and the tip of projection 132. As a result, the damping member 133 of the present embodiment is integrally formed by filling for example the damping member such as gels for the UV curing into the gap Δc, and by curing them.

As described above, the mirror 110, the mirror holder 111 and first and second coils C1, C2 constitute a movable portion, and as shown in FIG. 6, the center of gravity G of the movable portion is positioned on the rotation axis Ox and also the rotation axis Oy. Moreover, the principal axis of inertia of the movable portion is corresponding to the rotation axis Ox and the rotation axis Oy. Moreover, the damping member 133 is arranged in closely near the center of gravity G, and the rotation axes Ox and Oy.

Moreover, the spring 112 is arranged so as to correspond on the plane constituted by the rotation axis Ox and the rotation axis Oy. Moreover, the first deforming portion 112a shown in FIG. 5 is arranged at the position corresponding substantially to the rotation axis Ox, and the second deforming portion 112b is arranged at the position corresponding substantially to the rotation axis Oy.

As shown in FIG. 6, the spring 112 is not arranged at the central position of the first coil C1 and the second coil C2 fitted before and after thereof, and but arranged at the position of the first coil C1 placing the mirror 110 thereon, slippage. As a result, the position of center of gravity including the mirror 110 can be matched to the rotation axes Ox and Oy without the balancer

Moreover, FIG. 6 is a cross-sectional view showing a horizontal plane including the rotation axis Oy. As shown in FIG. 6, the power along the vertical direction of the drawing to the driving point F1 is caused on the first coil C1. Therefore, the torque about the middle point Fm1 connecting two driving points F1 and F1 at both sides of the first coil C1, is caused. And, the torque about the driving point F1 and the middle point Fm1, is positioned on the horizontal plane including the rotation axis Oy.

Power is caused in the second coil C2 near the arm of the front-back(inside and outside) direction of FIG. 6, and the power is caused in the vertical direction on upper and lower planes perpendicular to the paper plane of FIG. 6 to driving point F2 of FIG. 6. Therefore, the torque about the middle point Fm2 (in FIG. 6, two driving points F2, F2 are matched to the middle point Fm2.) connecting two driving points F2 and F2 at both sides of the second coil C2, is caused. Moreover, FIG. 8 is a cross-sectional view showing a vertical plane including the rotation axis Ox, and as is seen from this FIG. 8, it is understood that the torque about the driving point F2 and the middle point Fm2, is positioned on the vertical plane including the rotation axis Ox.

That is, as shown in FIG. 6, the torque about the middle point F1(m) and the torque about the middle point Fm2 are formed to obtain a short distance to center of gravity G.

The housing 100a has the sensor for detecting the inclination of the mirror 110 accompanying to the rotation around the rotation axes Ox and Oy. As shown in FIGS. 3 and 7, the housing 100a is secured by press-fitting the laser 140 (diode) as a light source for the sensor to the opening 100b at the rear end of the housing 100a. Moreover, PBS 152 (polarization beam splitter) connecting the ¼λ plate 151, is disposed forward of the laser 140, and one side 151b of the PBS 152 (adhesive plane) is adhered and fixed to the inner wall plane of (one of) the housing 100a.

In addition, a lens 153 is cemented and fixed forward of a PBS 152 by housing 100a. And, the laser beam due to the laser 140 is irradiated on the plate 130 fixed to the magnet holder 120, through the PBS 152, the ¼λ plate 151, and the lens 153, and thus the light capable of passing over the surroundings of the projection 132 formed in the plate 130 is incident on the back 110b of the mirror 110 held to the lens holder 111. Moreover, the inner wall shape of the reverse side of the lens holder 111 forms the circular opening 111b (refer to FIG. 5).

In addition, as shown in FIG. 7, the housing 100a is opened at the position opposite to the inner wall surface, to which the side 151b of the PBS 152 is adhered, and a position detecting sensor (PSD) 154 for detecting the light illuminating central position in two directions of the projected light, is adhered and fixed at the opening part. The PSD 154 is a two dimensional position sensor for outputting the central position in two direction (X and Y directions) of the light projected on the light receiver 154 by a voltage.

Next, the action of the galvanometer mirror 100 is explained. When an electric current flows in the first coil C1 through two of four springs 112, the rotating torque is caused around the rotation axis Ox by the magnetic field received from the magnet m1 arranged on both right and left sides thereof, so that the first deforming portion 112a is subjected to the torsional deformation, chiefly, thereby inclining the movable portion around the rotation axis Ox (making rotation).

When an electric current flows in the second coil C2 through another two of four springs 112, the rotating torque is caused around the rotation axis Oy by the magnetic field received from the magnet m2 arranged on both upper and under sides thereof, the second deforming portion 112b is subjected to the torsional deformation, chiefly, thereby inclining the movable portion around the rotation axis Oy (making rotation).

The laser beam generated by the laser 140 is p-polarized and incident on the PBS 152, the laser beam penetrates the polarization plane 152a with almost 100 percent, the laser beam becomes the circular polarized light through the ¼λ plate 151 and incident on the lens 153, and thus the laser beam is focused by the lens 153 and is incident on the back 110b of the mirror 110. The light reflected on the back 110b transmits the ¼λ board 151, and becomes a s-polarized light where the plane of polarization is rotated by 90 degrees, and the s-polarized light is incident on the plane of polarization 154a, so that the s-polarized light can almost reflect 100 percent here and is incident on the light receiving plane 154a of the PSD 154 in the spot shape.

When the mirror 110 is inclined around the rotation axis Ox, light on the light receiving plane 154a moves in the X direction of FIG. 3 (a right and left direction in FIG. 7), and when the mirror 110 is inclined around the rotation axis Oy, light on the light receiving plane 154a moves in the Y direction (a vertical direction in FIG. 7) so that the inclination in two directions of the mirror 110 can be detected by the output of the PSD 154.

Therefore, by supplying the driving signal in which the position detection signal from the PSD 154 reaches the desired value for the first coil C1 and the second coil C2, the control can be performed to the desired value in which the inclination of (the reflection plane 110b of) the mirror 110 together with the movable portion.

The damping member 133 is arranged in the direction perpendicular to the reflection plane 110f of the mirror 110, and in the direction where the rigidity of the spring 112 is low. As a result, the rigidity in the direction vertical to the reflection plane 110f of the mirror 110, that is, the direction in which the rigidity of four springs 112 is low, can be greatly raised, since the damping member 133 becomes a support member in this direction.

For example, the resonance frequency of the movable portion in the vertical direction is about 80 Hz, in the case that the movable portion is supported only by the support member, but, in the case that the movable portion is supported by the connection or the touch with the damping member 133, the resonance frequency of the movable portion in the vertical direction can be improved to 400 Hz. Therefore, the amplitude of the mirror 110 that vibrates in the direction perpendicular to the reflection plane 110f of the mirror 110, can be reduced, and thus the reflected light L2 is never needlessly displaced.

The damping member 133 is located at the center of the back 110b in the direction perpendicular to the reflection plane 110f of the mirror 110, and is set at a position near the rotation center of the movable portion. As a result, in the case or the like that the movable portion including the mirror 110 receives the outer vibration in the direction perpendicular to the reflection plane 110b of the mirror 110, the vibration of the movable portion can be effectively controlled. Moreover, even in the case of rotating the movable portion around the rotation axis Ox or the rotation axis Oy, the damping member 133 is subjected to the deformation, so that the vibration of this direction can also be controlled.

Moreover, the damping member 133 is arranged near the rotation center of the movable portion and the mirror 110. Therefore, the deformation, that damping member 133 receives in case of inclining the movable portion, does not become excessive, so that the sensitivity of the motion of the movable portion might not be decreased large. Moreover, the damping member 133 is arranged only in a central portion of the mirror 110, so that the inclination of the mirror 110 can be detected by light transmitted through the circumference thereof.

In the galvanometer mirror 100 for inclining the mirror 110 around two axles, a member for supporting two kinds of coils C1 and C2 inclined in the directions of two axes and constituted with the mirror 110 integrally, is displaced in such a manner that the spring 112 including the rotation center in two directions is sandwiched in the direction perpendicular to the reflection plane 110f of the mirror 110. Therefore, the center of the driving torque of coils C1 and C2 can be set so as not to deviate the support member and the rotation center large. Therefore, the center of the driving torque of coils C1 and C2 can be set so as not to deviate for the support member and the rotation center large

Moreover, the center of gravity place of the movable portion including coil C1 and C2 of 2 varieties can be easily matched to the rotation center. Therefore, in the drive performance of the inclination of the mirror 110, the generation of the resonance can be controlled, and thus the servo characteristic can be improved.

In addition, the coils C1 and C2 inclined in two directions are arranged on both sides of the support member, and are separated in the direction vertical to the reflection plane 110f of the mirror 110. Therefore, two coils C1 and C2 and the magnets m1 and m2 constructing respective magnetic circuits can easily be arranged without each interfering. With such an arrangement, even if two coils C1 and C2 are separated in the direction vertical to the reflection plane 110f of the mirror 110, the deviation to the support can be reduced. Therefore, the magnets m1 and m2 for two directional rotation can be easily arranged and the mutual magnetic interference between the magnets m1 and m2 for two directional rotation can be reduced, and thus the disorder of the magnetism effected on two coils C1 and C2 can be reduced.

In this embodiment, the spring 112 are made to be four, so that the total four feeding power lines of respective +/− of the coils C1 and C2 for generating the driving force in two directions (driving line) can be held concurrently. Therefore, the flexible cable for feeding power to the movable portion etc. become unnecessary, and does not influence on the supporting drive operation of the mirror 110.

Moreover, in this embodiment, the dumpers D1 and D2 are arranged at both ends of the spring 112 so that the vibration caused in the case of twist deformation of the spring 112 can be effectively controlled. In addition, the inclination sensor of the mirror 110 is arranged in the reverse side on the back side to the reflection plane 110f for the main ray. Therefore, the inclination sensor can make it not interfere with the principal ray.

In this embodiment, the plate 130 is used, but the cylindrical projection 132 can also be fixed directly to the surface of the lens 153 as a fixing portion of the lens 153. Moreover, the damping member such as silicone rubbers formed in the form of a cylinder previously may be connected to the surface of the lens 153 and the back 110b of the mirror 110. The damping member such as silicone rubbers formed in the cylindrical shape previously may also be disposed in such a manner that the surface of the lens 153 and the back 110b of the mirror 110 are connected.

The gel, such as for example, TB3168 and TB3169 of Three Bond Co. as acrylic gel or silicone gel and CY52-276 of Dow Corning Toray Co., Ltd.; the silicone rubber, such as for example, JCR6126 and SE1821 of Dow Corning Toray Co., Ltd., KE109 of Shin-Etsu Chemical Co. Ltd., and TB1220D of Three Bond Co.; and the grease or oil, such as for example oil or grease etc. of the KRYTOX series of the Du Pont K.K.; can be used variously. In the case of the damping member that does not harden such as oil or grease, etc, these damping members are held in the space between the back 110b and the projection 132 of the mirror 110 with the surface-tension or the viscosity. The damping member 133 is not limited to the gel, and can be used to the rubber, the oil, and the grease, etc.

In addition, the back 110b of the mirror 110 is made a transmission plane, the constitution that uses the reflection plane 110f of the mirror 110 on which the main Ray for the sensor can be reflected, may also be acceptable. Moreover, the damping member 133 may be arranged between the mirror holder 111 or the coil C2 on the side of lens 153 and the housing 100a, instead of the back 110b of the mirror 110.

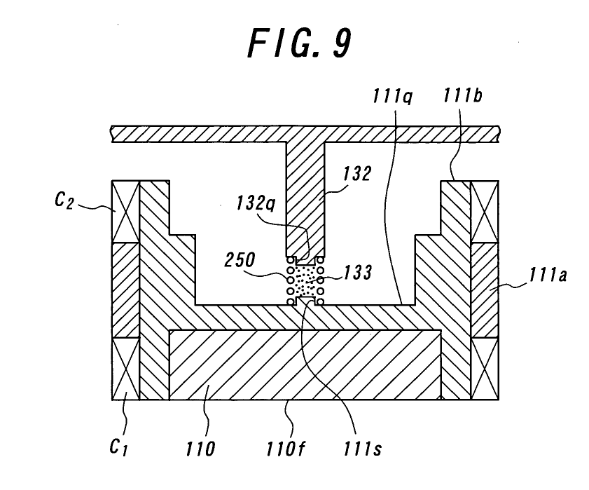

Moreover, when the sensor such as the present embodiment is not used, the wall is provided by closing the opening of a central portion of the mirror holder 111 arranged to the other side of the reflection plane 110f of the mirror 110, and the damping member 133 can be arranged on the wall. Next, the modification of the first embodiment is explained with the use of FIG. 9. The mirror holder 111 is provided with the mirror plane 111q, and the reflection coating of gold is applied to the mirror plane, so that the function similar to the back 110b of the mirror 110 in the first embodiment is provided. The cylindrical projection 111s is provided at the part corresponding to the projection 132 to the mirror holder 111, and the coil spring 250 formed with extra fine wire of about 10 μm of a stainless is arranged so as to connect tips of the projection 111s and the projection 132. The damping member 133 is filled and harden in the space enclosed with the tips of the projection ills and the projection 132, and inside of the coil spring 250. The damping member is filled in the space enclosed with the damping member by the coil spring 250, so that the effect to which outer dimension of the damping member is stable, is provided.

By the way, the mirror portion of the galvanometer mirror may also be a structure for tilting the mirror portion directly, without utilizing the holder.

Moreover, the present invention is constituted as a moving coil system in which the coil is displaced on the movable portion, and the magnet is displaced on the fixing portion, but, oppositely, it may be constituted as a moving magnet system, in which the coil is displaced on the fixing portion and the magnet is displaced on the fixing portion. Moreover, the optical deflection element is not limited to the mirror, but may be made as the prism and the hologram element, etc. Moreover, the plate 130, the projection 132, and the damping member 133 may be formed integrally with each other by the plastic having the damping characteristic, and the tip thereof may also be adhered to the back side 110b, or, the mirror or the coil holder is formed with the plastic having the damping characteristic, and the damping member 133 may also be formed integrally with the mirror or the coil holder at the same time.

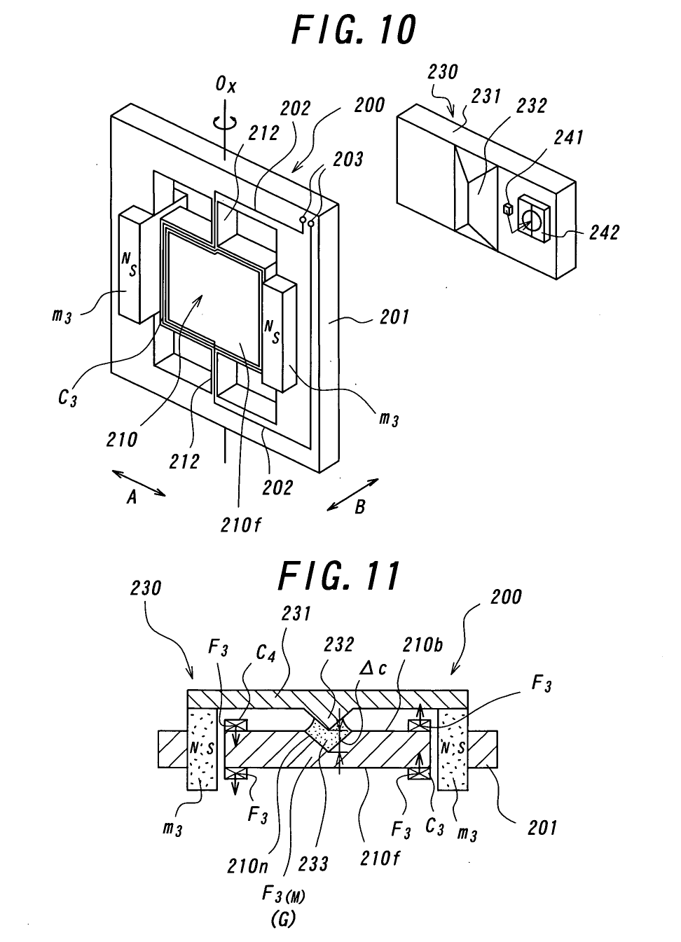

Next, the second embodiment of the present invention is explained referring to FIGS. 10 and 11. Moreover, the galvanometer mirror 200 of the present embodiment is a structure rotating about one axial.

The galvanometer mirror 200 shown in FIG. 10, is constructed by the frame 201, the squarish tabular mirror 210 at its center, and a spring 212 for connecting the frame 212 extended thinly and straight in vertical direction, respectively, at the central position in a right and left directions of an upper and an under arms of the mirror 210, by etching the silicon substrate in the semiconductor process.

As shown in FIG. 11, quadrangular coils C3 and C4 are formed on both sides of the mirror 210 with electroformed. The terminals of these coils C3 and C4 are connected to the soldering land 203 provided on the frame 201 by the conductive pattern 202 formed on both sides of two straight spring portions 212 (and the frame 201). The coils C3 and C4 on both sides are constituted in such a manner to surround the spring portion 212 as the support member, the mirror 210 and the rotation axis Ox formed as medial axis of the mirror 210.

Two magnets m3 are adhered and fixed to the frame 201 at the positions opposite to two coils C3 and C4, respectively, under the stats positioned to the notch portion of the frame 201. The reflection plane 210f with improved reflectivity, is formed on the surface of the mirror 210 by applying, for example, the gold coating film thereon. Moreover, the coating film such as gold with high reflectivity for light for the sensor is also applied to the back of the mirror 210.

As shown in FIG. 11, V groove 210n is formed on back 210b of the mirror 210 inside of the coil C3, and the plate 230 is arranged at the opposed side thereto.

The pate 230 has the fixing portion 231 with the magnet m3 fixed at both ends and the projection 232 with a triangular cross-section of the roof type extended to the back 210b of the mirror 210 from the front side at a central portion of the main body portion 231, and the damping member (damping member) 233 contacted to the V groove 210n formed in the back 210b of the mirror 210, is provided to the tip of the projection 232.

In this embodiment, similar to the first embodiment, when the plate 230 is fixed to the back 210b of the mirror 210, slight space Δc (for example, 0.2-1 mm) is caused between the V groove 210n and tips of projection 232 of the mirror 210. As a result, the damping member 233 of the present embodiment is also molded integrally for example by filling the damping member consisting of such as the UV curing gels in the space Δc and then by the curing.

Therefore, according to the present embodiment, the vibration around the rotation axis Ox of mirror 210 and the vibration in the direction perpendicular to the reflection plane 210f of the mirror 210, can be effectively controlled, or suppressed. Moreover, in this embodiment, the rotation axis adjusting the inclination of the mirror 210, is only one axle, so that the damping member 233 is arranged in linearly at the center of the mirror 210.

In addition, as shown in FIG. 10, as the plate 230 in this embodiment, an LED (light emitting diode) 241 and a PD (photodiode) 242, of which the light receiving surface is divided into two, are arranged. In this case, after reflecting at the back 210b, the light emanated from the LED 241 is incident on the divided PD 242. Therefore, by taking the difference of respective outputs of the PD 242, the amount of rotation around the rotation axis Ox of mirror 210, can be detected.

In two coil C1 and C2, the force is caused at driving point F3 as shown in FIG. 11, so that the center of the torque due to the driving force lies in the middle point Fm3. That is, as shown in FIG. 11, the galvanometer mirror 200 of the present embodiment has a symmetrical construction in such a manner that the rotation axis Ox and the center Fm3 of the torque are correspondent at the center of gravity G of the movable portion constituted by the mirror 210 and the coils C3 and C4.

Therefore, according to the present embodiment, as to the feeding power lines to two coils C3 and C4, four feeding power lines were formed on both sides of the supporting spring portion 212 at two places, by utilizing both sides of the spring portion 212 supporting the mirror 210, so that only one feeding power line may be disposed on each face of the spring portion. Therefore, even if the width of the spring portion 212 is narrow, the feeding power line can be arranged easily. In the present embodiment, the rigidity in the vertical direction on the reflection plane 210f of the mirror 210 is increased, and the vibration can be controlled effectively.

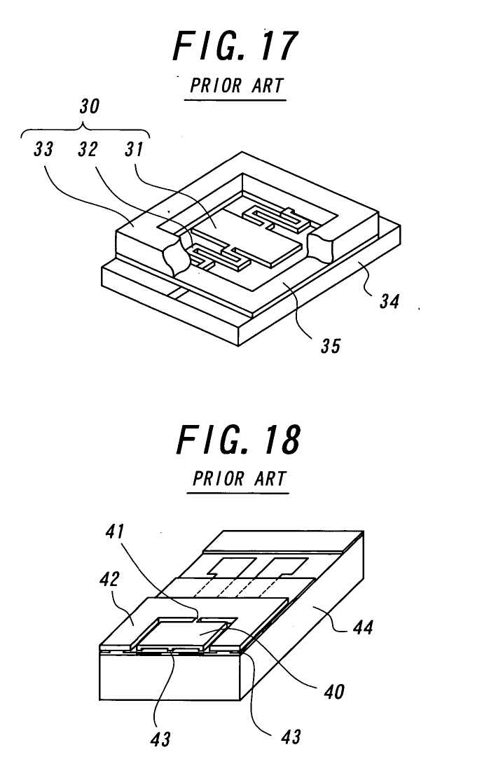

Moreover, the frame 201 and the movable portion can be easily manufactured according to the semiconductor process, so that productivity becomes excellent. Moreover, they are a completely symmetry to the rotation axis Ox, so that they can be set in a state of being able the balance in complete (high accuracy), and thus the setting for matching the center of the torque to the rotation axis Ox as the center of gravity G and the rotation center, can be performed with high accuracy. In the above embodiments, the damping member is made to be a support member in the direction perpendicular to the reflection plane of the mirror, but, the damping member may be made a hinge etc. of soft plastic molding member such as nylon. In addition, the present invention is not limited to the optical communication, but for example can be applied to the tracking device or the like of an optical recording/reproducing apparatus. In this embodiment, use is made of the electromagnetic drive de to the coil and the magnet, but, the electrostatic micro actuator and other type of driving system, such as conventional embodiment shown in FIG. 17, may also be applied.

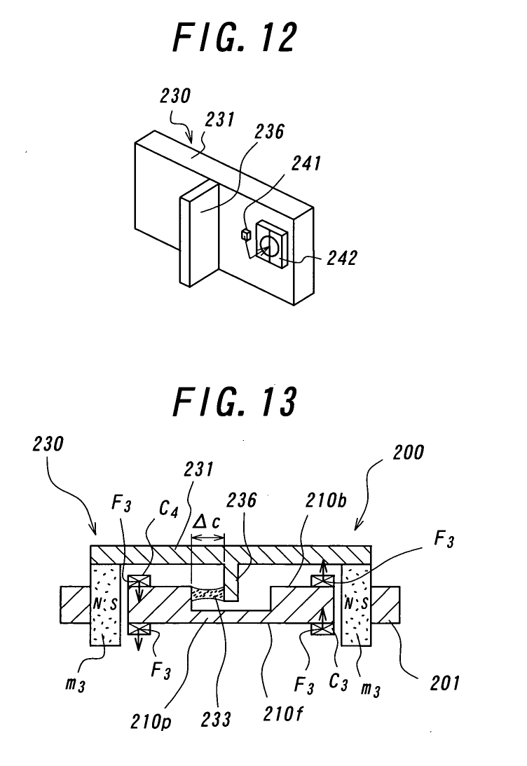

FIGS. 12 and 3 show the modified embodiments of the above described second embodiment. Moreover, the same referential numerals are used to similar components as components shown in FIGS. 10 and 11.

As shown in FIG. 10, the size of cross-section of the spring member 212 is larger than the size in B direction perpendicular to the reflection plane 210f, compared with A direction parallel to the reflection plane 210f. Therefore, the spring portion 212 is low in rigidity in the A direction from rather than in the B direction, so that the mirror 210 comes to vibrate easily in the A direction.

Therefore, as shown in FIG. 12, it is preferable that a plate member 236 is provided so as to connect it to the main body portion, as a result, in the case of supporting the mirror 210, as shown in FIG. 13, the rectangular recess portion 210p is provided in place of V groove 210n, and thus the damping member 233 is provided in such a manner that the side of plate member 236 and the side of recess portion 210p are so connected in the direction that the rigidity of the spring portion 212 becomes low. As a result, even in the case that a horizontal stress acts on the mirror 210, the small rigidity in B direction of the spring portion 212 can be supplemented enough, and thus the mirror 210 can be supported enough.

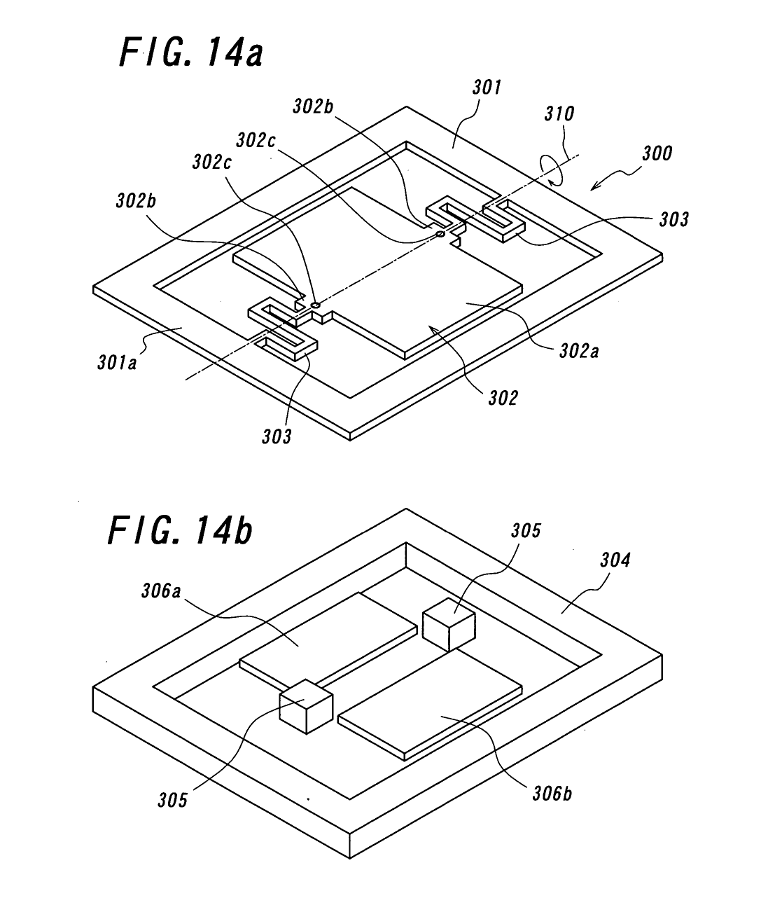

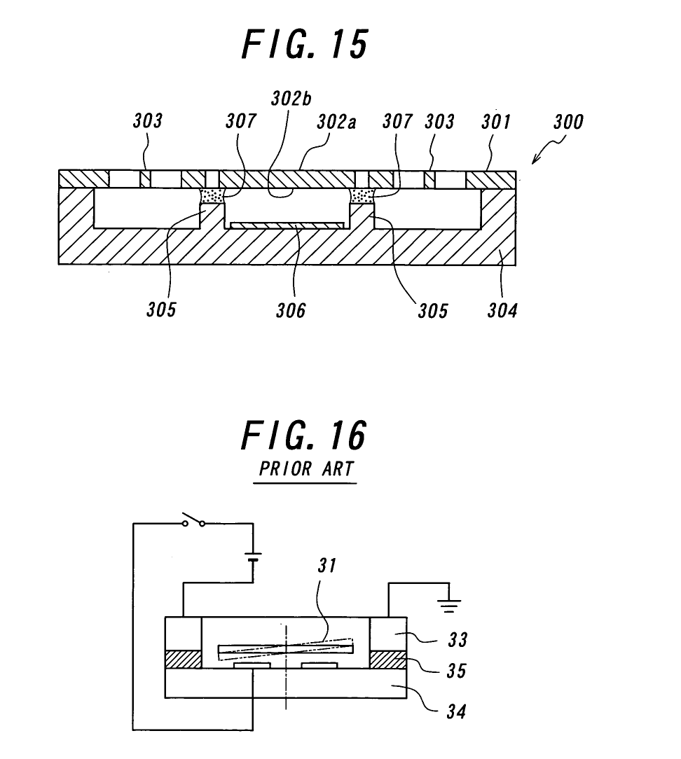

Next, the FIGS. 14 and 15 explain as to the embodiment using the electrostatic force for the driving section. A mirror portion 302 is formed at the center portion of an upper plate 301, on which a silicon substrate is formed with the etching process, and the surface of the mirror portion 302 is applied with gold coatings, thereby forming a mirror surface 302a with high reflectance. A projection 302b is formed on the both sides thereof, and a hole 302c is formed at the center thereof. Moreover, an S shaped spring portion 303 is thinly formed in the outer side of the projection 302b, and the fixing portion 301a and the projection 302b are connected by the spring portion 303. A silicon substrate is formed on a lower plate 304 with the etching process, a central portion thereof is formed to concave shape, and two electrode portion 306a and 306b are formed on the bottom thereof.

A projection 305 is formed to the portion opposed to the projection 302b with a little space of about 0.1-0.5 mm.

The above plate 301 has a fixing portion 301a, which is fixed to the lower plate 304 on the outer periphery side thereof. Damping material 307 being liquid UV curing gel, is injected from the holes 302c into the spacing between the projections 306a, 306b, and the projections 302b, 302b, respectively and is hardened by UV.

The electrostatic force is generated by applying the voltage between electrodes 306a, 306b, and rear faces 302b of the mirror portion 302, so that the mirror portion 302 inclines around an axle 310.

Even in the present embodiment, the damping material is arranged between the movable portion and the fixing portion in the direction perpendicular to the reflection plane so that the vibration in the direction perpendicular to the reflection plane can be effectively controlled. In the present embodiment, the hole is provided to apply the damping member, so that the damping member can be injected easily.

What is claimed is:

1. An optical deflection device comprising an optical deflection element having a prescribed deflecting plane of deflecting a direction of light, a drive portion for driving the optical deflection element rotatably at least, a fixing portion for supporting and fixing the optical deflection element, a movable portion including above optical deflection element, a support member connected with the fixing portion and for supporting this, and a damping member installed between the movable portion and the fixing portion.

2. An optical deflection device as claimed in claim 1, wherein the damping member is provided in the vertical direction substantially compared with the deflecting plane.

3. An optical deflection device as claimed in claim 1, wherein the damping member is provided in neighborhood at the rotation center of the optical deflection element.

4. An optical deflection device as claimed in claim 1, wherein the damping member is provided at the center part of the movable portion substantially at the rear side opposed to the deflecting plane of the optical deflection element.

5. An optical deflection device as claimed in claim 4, wherein the fixing portion has a projection extended to the rear side of the optical deflection element almost in the center part, and the damping member is provided between the movable portion and the projections of the fixing portion.

6. An optical deflection device as claimed in claim 5, wherein the damping member has a cylindrical shape.

7. An optical deflection device as claimed in claim 1, wherein the damping member constituted with gel, rubber, grease or oil.

8. An optical deflection device as claimed in claim 1, wherein the optical deflection element is an optical element using the reflection action or the refraction action.

9. An optical deflection device as claimed in claim 1, wherein the drive portion comprises a coil provided so as to support the optical deflection element indirectly or directly, and a magnet installed in periphery of the coil.

10. An optical deflection device as claimed in claim 9, wherein the coil contains a first coil and a second coil, and the magnet is installed at outside of the first coil and the second coil.

11. An optical deflection device as claimed in claim 1, further comprising a frame member for supporting the optical deflection element directly.

12. An optical deflection device as claimed in claim 11, wherein the coil is built into the frame member.

13. An optical deflection device as claimed in claim 1, further comprising a light emitting source for irradiating prescribed light to the movable portion, at the rear side opposed to the deflecting plane of the optical deflection element, and a sensor for detecting the gradient of the deflecting plane opposed to the deflecting plane of the optical deflection element, by receiving the light.

14. An optical deflection device as claimed in claim 13, wherein the photo detector for position detection is included in the sensor.

15. An optical deflection device as claimed in claim 13, wherein the damping member is provided on the deflecting plane in the substantially vertical direction.

16. An optical deflection device as claimed in claim 13, wherein the damping member is provided in neighborhood at the rotation center of the optical deflection element.

17. An optical deflection device as claimed in claim 13, wherein the damping member is provided at the center part of the movable portion substantially at the rear side opposed to the deflecting plane of the movable portion.

18. An optical deflection device as claimed in claim 17, wherein the fixing portion has a projection extended to the rear side of the movable portion almost at the center part, and the damping member is provided between the movable portion and the projections of the fixing portion.

19. An optical deflection device as claimed in claim 18, wherein the damping member has a cylindrical shape or a plate shape.

20. An optical deflection device as claimed in claim 13, wherein the damping member is constituted with gel, rubber, grease or oil.
